(19) United States
(12) Patent Application Publication
(10) Pub. No.: US 2016/0368708 A1
(43) Pub. Date: Dec. 22, 2016

(54) Paper Bag Support System

(71) Applicant: Elaine Mager, Dunwoody, GA (US)

(72) Inventor: Elaine Mager, Dunwoody, GA (US)

(21) Appl. No.: 14/744,238

(22) Filed: Jun. 19, 2015

(51) Int. Cl. B65F 1/14; F16M 11/22

(52) U.S. Cl. CPC B65F 1/1415; F16M 11/22

(57) ABSTRACT

A paper bag support system includes a panel having a top side, a bottom side and a perimeter edge. The panel has an opening therein extending into the top side and outwardly of the bottom side. A plurality of legs is attached to and extends downwardly from the panel. A plurality of supports is provided and each of the supports is attached to the bottom side of the panel and extends downwardly therefrom. The supports are configured to be extended into a lawn bag to retain the lawn bag in an upright position.

### BACKGROUND OF THE DISCLOSURE

### Field of the Disclosure

The disclosure relates to refuse bag support devices and more particularly pertains to a new refuse bag support device for retaining a lawn waste bag in an upright position while it is being filled.

### SUMMARY OF THE DISCLOSURE

An embodiment of the disclosure meets the needs presented above by generally comprising a panel having a top side, a bottom side and a perimeter edge. The panel has an opening therein extending into the top side and outwardly of the bottom side. A plurality of legs is attached to and extends downwardly from the panel. A plurality of supports is provided and each of the supports is attached to the bottom side of the panel and extends downwardly therefrom. The supports are configured to be extended into a lawn bag to retain the lawn bag in an upright position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a paper bag support system according to an embodiment of the disclosure.

FIG. 2 is a front view of an embodiment of the disclosure.

FIG. 3 is a cross-sectional view of an embodiment of the disclosure taken along line 3-3 of FIG. 1.

FIG. 4 is a bottom view of an embodiment of the disclosure.

FIG. 5 is a front in-use view of an embodiment of the disclosure.

### DESCRIPTION OF THE PREFERRED EMBODIMENT

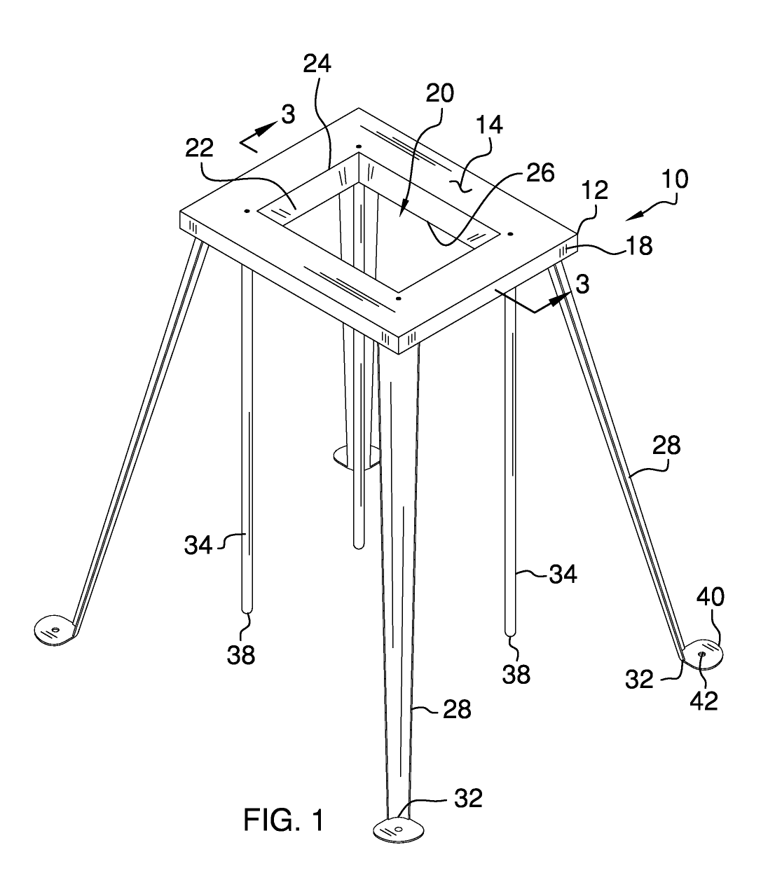

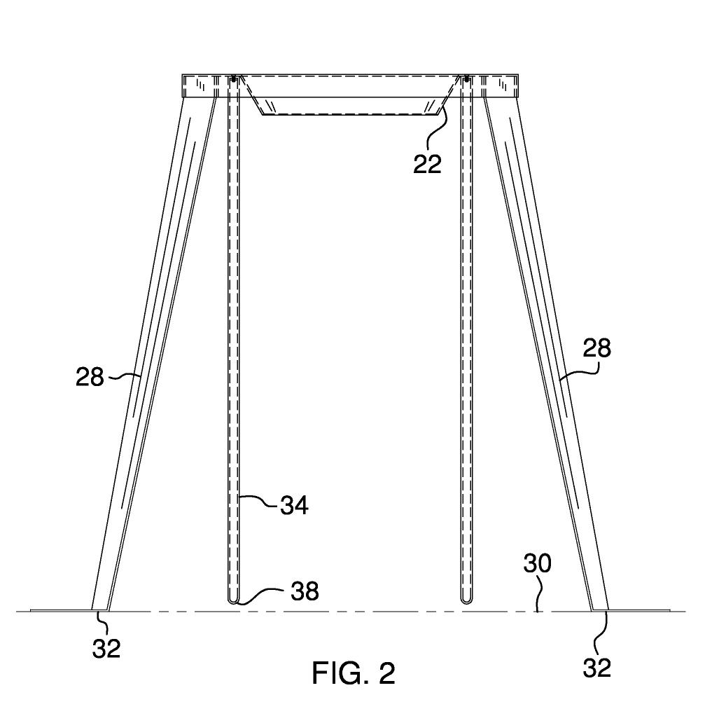

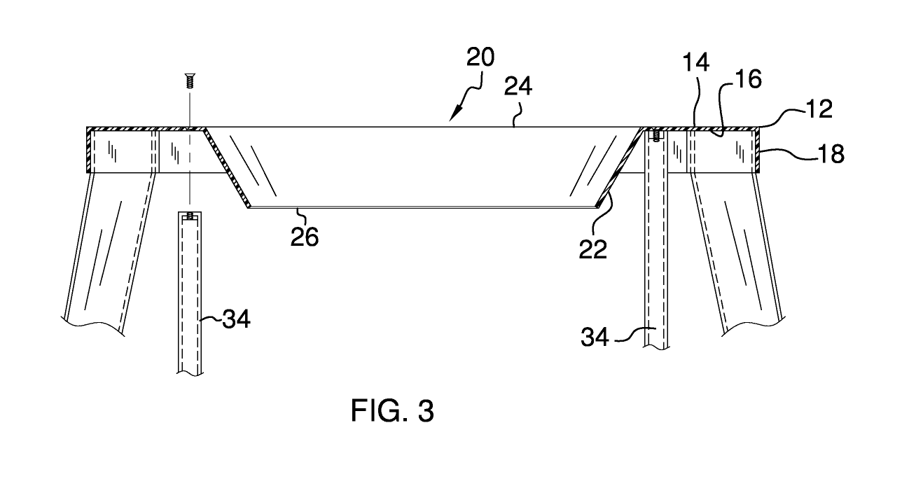

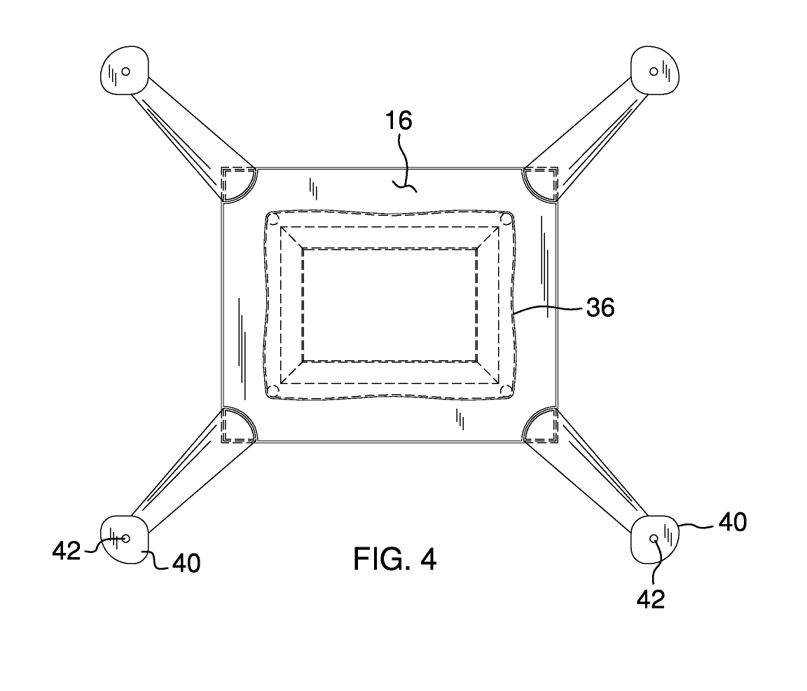

With reference now to the drawings, and in particular to FIGS. 1 through 5 thereof, a new refuse bag support device embodying the principles and concepts of an embodiment of the disclosure and generally designated by the reference numeral 10 will be described.

As best illustrated in FIGS. 1 through 5, the paper bag support system 10 generally comprises a panel 12 that has a top side 14, a bottom side 16 and a perimeter edge 18. The panel 12 has an opening 20 therein extending into the top side 14 and outwardly of the bottom side 16. The opening 20 has a rectangular shape and may have a length and width each between 10.0 inches and 18.0 inches. More particularly, the opening 20 may have a length equal to about 12.0 inches and a width equal to about 16.0 inches. A funnel 22 may be coextensive with a peripheral edge 24 of the opening 20 and extends downwardly therefrom. The funnel 22 tapers inwardly from the panel 12 to a distal edge 26 of the funnel 22 with respect to the panel 12. The funnel 22 may extend downwardly from the panel 12 a distance of less than 6.0 inches.

A plurality of legs 28 is attached to and extends downwardly and outwardly from the panel 12. The legs 28 may be angled outwardly from the panel 12 as shown in the Figures to provide greater stability for the panel 12. The legs 28 space the panel 12 from a support surface 30 a distance of between 33.0 inches and 36.0 inches when a bottom end 32 of each of the legs 28 is abutted against the support surface 30. The support surface 30 will typically be a ground surface such as grass covered soil.

A plurality of supports 34 is provided and each is attached to the bottom side 16 of the panel 12 and extends downwardly therefrom. The supports 34 are configured to be extended into a lawn bag 36 to retain the lawn bag 36 in an upright position. Each of the supports 34 extending at least 30.0 inches downwardly from the panel 12 and the supports 34 may be removable from the panel 12. The plurality of supports 34 comprises four supports 34. The opening 20 has four corners and each of the corners has one of the supports 34 positioned adjacent thereto. Each of the supports 34 has a terminal end 38 positioned opposite of the panel 12 wherein each of the terminal ends 38 each is rounded to prevent tearing of the lawn bag 36.

A plurality of plates 40 is provided. Each of the bottom ends 32 of the legs 28 has one of the plates 40 attached thereto. The plates 40 are oriented horizontal and lie in a same plane with respect to each other. The plates 40 each have an aperture 42 extending therethrough. A plurality of stakes 44 is provided. Each of the apertures 42 has one of the stakes 44 extending therethrough. The stakes 44 are configured to extend into the support surface 30.

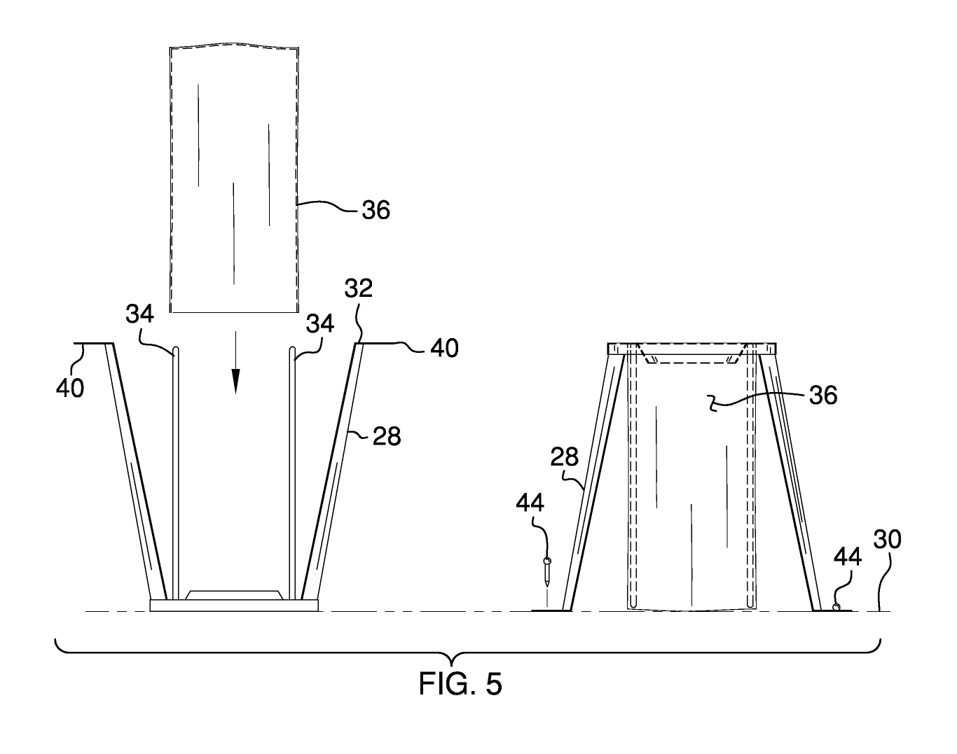

In use, the panel 12 and legs 28 are turned upside down as shown in FIG. 5 so that the bag 36 may be aligned with the opening 20 and receive the supports 34. The panel 12 is then turned right side up and the stakes 44 may be used to secure the plates 40 in place. The lawn bag 36 may then be filled with lawn waste such as grass clippings, leaves, weeds, dead plants and the like. The funnel 22 ensures that the lawn waste travels into the lawn bag 36 and does not fall outside of the lawn bag 36 as it is being filled.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A paper bag support assembly configured to retain a paper bag in an upright orientation while the paper bag is filled with yard waste, said assembly comprising:
a panel having a top side, a bottom side and a perimeter edge, said panel having an opening therein extending into said top side and outwardly of said bottom side;
a plurality of legs being attached to and extending downwardly from said panel, each of said legs having a bottom end, a length of each of said legs extending from said panel being such that said bottom ends are coplanar; and
a plurality of supports, each of said supports being attached to said bottom side of said panel and extending downwardly therefrom, wherein said supports are configured to be extended into a lawn bag to retain the lawn bag in an upright position, each of said supports having a terminal end, said terminal ends of said supports being positioned in a plane spaced upwardly and parallel to said distal ends of said legs, each of said terminal ends having a hemi-spherical surface.

2. The paper bag support assembly according to claim 1, wherein said opening has a rectangular shape, said opening having a length and width each between 10.0 inches and 18.0 inches.

3. The paper bag support assembly according to claim 1, further including a funnel being coextensive with a peripheral edge of said opening and extending downwardly therefrom, said funnel tapering inwardly from said panel to a distal edge of said funnel with respect to said panel.

4. The paper bag support assembly according to claim 3, wherein said funnel extends downwardly from said panel a distance of less than 6.0 inches.

5. The paper bag support assembly according to claim 1, wherein each of said supports extends at least 30.0 inches downwardly from said panel said legs spacing said panel from a support surface a distance of between 33.0 inches and 36.0 inches when said bottom end of each of said legs is abutted against the support surface.

6. The paper bag support assembly according to claim 2, wherein said plurality of supports comprises four supports, said opening having four corners and each of said corners having one of said supports positioned adjacent thereto.

7. (canceled)

8. The paper bag support assembly according to claim 1, further including:
a plurality of plates, each of said bottom ends of said legs having one of said plates attached thereto, said plates being oriented horizontal and lying in a same plane with respect to each other, each of said plates having an aperture extending therethrough; and
a plurality of stakes, each of said apertures having one of said stakes extending therethrough, each of said stakes being configured to extend into the support surface.

9. A paper bag support assembly configured to retain a paper bag in an upright orientation while the paper bag is filled with yard waste, said assembly comprising:
a panel having a top side, a bottom side and a perimeter edge, said panel having an opening therein extending into said top side and outwardly of said bottom side, said opening having a rectangular shape, said opening having a length and width each between 10.0 inches and 18.0 inches;
a funnel being coextensive with a peripheral edge of said opening and extending downwardly therefrom, said funnel tapering inwardly from said panel to a distal edge of said funnel with respect to said panel, said funnel extending downwardly from said panel a distance of less than 6.0 inches;
a plurality of legs being attached to and extending downwardly and outwardly from said panel, each of said legs having a bottom end, a length of each of said legs extending from said panel being such that said bottom ends are coplanar, said legs spacing said panel from a support surface a distance of between 33.0 inches and 36.0 inches when said bottom end of each of said legs is abutted against the support surface;
a plurality of supports, each of said supports being attached to said bottom side of said panel and extending downwardly therefrom, wherein said supports are configured to be extended into a lawn bag to retain the lawn bag in an upright position, each of said supports having a terminal end, said terminal ends of said supports being positioned in a plane spaced upwardly and parallel to said bottom ends of said legs, each of said supports extending at least 30.0 inches downwardly from said panel, said plurality of supports comprising four supports, said opening having four corners and each of said corners having one of said supports positioned adjacent thereto, each of said terminal ends having a hemi-spherical surface;
a plurality of plates, each of said bottom ends of each of said legs having one of said plates attached thereto, said plates being oriented horizontal and lying in a same plane with respect to each other, each of said plates having an aperture extending therethrough; and
a plurality of stakes, each of said apertures having one of said stakes extending therethrough, each of said stakes being configured to extend into the support surface.
